(19) United States
(12) Patent Application Publication
(10) Pub. No.: US 2008/0288951 A1
(43) Pub. Date: Nov. 20, 2008

(54) Method, Device And System For Allocating A Media Resource

(75) Inventors: Lin Lin, Shenzhen (CN); Yanyu Wu, Shenzhen (CN); Tao Song, Shenzhen (CN); Gaofeng Yang, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/181,797

(22) Filed: Jul. 29, 2008

Related U.S. Application Data
(63) Continuation of application No. PCT/CN2007/070612, filed on Sep. 3, 2007.

(30) Foreign Application Priority Data
Dec. 19, 2006 (CN) 200610157688.X

(51) Int. Cl. G06F 9/50

(52) U.S. Cl. 718/104

(57) ABSTRACT

A method and system for allocating a media resource and a device for controlling a media resource. The method for allocating a media resource includes: allocating the media resource processing devices for a resource operation request based on the stored ability information of the various media resource processing devices when the resource operation request is received; and updating the stored ability information of the media resource processing device dynamically. The device for controlling a media resource includes: a memory unit adapted to store the ability information of various media resource processing devices; an allocation unit adapted to allocate media resource processing devices for the resource operation request based on the ability information stored in the memory unit; a dynamic update unit adapted to update the ability information of the media resource processing device stored in the memory unit dynamically.

### CROSS-REFERENCE TO RELATED APPLICATIONS

This application is a continuation of International Application No. PCT/CN2007/070612, filed Sep. 3, 2007. This application claims the benefit of Chinese Application No. 200610157688.X, filed Dec. 19, 2006. The disclosures of the above applications are incorporated herein by reference.

### FIELD

The present disclosure relates to the field of communication, and in particular, to a method, a device and a system for allocating media resources.

### BACKGROUND

The statements in this section merely provide background information related to the present disclosure and may not constitute prior art.

With the continuous development of communication technologies, the requirements on media resource components become stricter and stricter. For example, in Next Generation Network (NGN), a Media Gateway Controller (MGC) controls a media resource server (MRS) and provides a Media resource Function (MRF) externally. Taking 3G networking as an example, MRF is disassembled into Media Resource Function Control (MRFC) and Media Resource Function Process (MRFP). The MRFC is responsible for the control and access of media resources, the MRFP is responsible for media resource processing, and the MRFC and the MRFP cooperate to provide media resource function externally. One MRFC may manage and control a plurality of MRFPs to provide resources externally. When an MRFC controls a plurality of MRFPs, there may exist a consideration of how to select an MRFP by the MRFC. After receiving a media resource request, the MRFC needs to select an MRFP for media resource processing. But the MRFC does not completely know the resource occupation situation on the MRFP, so it is possible for the MRFC to select an MRFP without resources. At this time, resource processing will be failed. If the MRFC selects an MRFP irregularly, load imbalance may be caused among MRFPs, and system stability will be affected.

In the prior art, in order to address this, an MRFC may designate an MRFP to perform media resource operation; if the media resources of the MRFP are insufficient, the MRFP will return an error which indicates that resources are insufficient, and at this time, the MRFC controls to select another MRFP to provide resources, or to release the call directly and indicate a failure. In a subsequent time period, the operation on the MRFP will be stopped. Because the MRFP is selected by an MRFC randomly, error probability during the process may be high due to the randomness of the selection. Load imbalance among MRFPs must also be considered and addressed.

### SUMMARY

The disclosure provides a method, a device and a system for allocating media resources, by means of which error probability during responding to a media resource request may be lowered and load balancing may be improved.

A method for allocating media resources includes: allocating a media resource processing device for a resource operation request according to saved capability information of each media resource processing device when receiving the resource operation request, and dynamically updating the saved capability information of each media resource processing device.

A media resource control device includes: a storage unit adapted to save capability information of each media resource processing device, an allocation unit adapted to allocate a media resource processing device for a resource operation request according to the capability information saved in the storage unit and a dynamic update unit adapted to dynamically update the capability information of each media resource processing device saved in the storage unit.

A system for allocating media resources includes: media resource processing devices each adapted to provide resources for a media resource operation request, a media resource control device adapted to allocate a media resource processing device for a resource operation request according to capability information of each media resource processing device saved currently when receiving the resource operation request, and dynamically update the saved capability information of each media resource processing device.

As can be seen from the above, in the disclosure, resources are allocated according to capability information of each media resource processing device saved currently, and the saved capability information is updated in time, so that resources may be allocated appropriately and load balancing may be realized. Therefore, error probability during the responding to a media resource request may be lowered, a better service may be provided to a user, and user satisfaction may be improved.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flow chart of a method for allocating media resources;

FIG. 2 is another flow chart of a method for allocating media resources;

FIG. 3 shows an embodiment of a media resource control device;

FIG. 4 is a block diagram showing an embodiment of a system for allocating media resources; and

FIG. 5 is a block diagram showing an embodiment of a media resource control device included in FIG. 4.

### DETAILED DESCRIPTION

The following description is merely exemplary in nature and is not intended to limit the present disclosure, application, or uses.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The embodiments are further illustrated in detail in conjunction with the drawings to make embodiments of the technical solutions and the advantages more apparent.

In NGN, the requesting entity of MRF may be a broadband terminal, and in a Third Generation (3G) network, it may be an Application Server (APP Server) or a terminal. In NGN, a media resource control device is referred to as Media Gateway Controller (MGC), a media resource processing device is referred to as Media Resource Server (MRS), and in a 3G network, a media resource control device is referred to as MRFC, a media resource processing device is referred to as MRFP. For the convenience of description, the embodiments will be explained with the terms in 3G as an example. However, it should be understood that the scope of the embodiments may also cover equivalent substitutions and alternatives of identical concepts, and should not be limited to the scope of 3G. Therefore, the scope of the embodiments should not be limited due to the difference of terms.

According to the embodiments, after a media resource control device allocates a media resource processing device for a resource operation request or an allocated media resource processing device is released, the media resource control device dynamically updates capability information of each media resource processing device recorded (i.e., saved) locally; when the media resource control device receives a resource operation request, the media resource control device allocates a media resource processing device for the resource operation request according to the capability information of each media resource processing device that is updated most recently (i.e., saved currently). The capability information may include one or more of the following items: resource idleness information, resource occupation information, overall resource information, classification information and capability type information. Other similar information may also be included. The dynamic updating process may be performed each time a media resource processing device is allocated for a resource operation request or an allocated media resource processing device is released, or may also be performed periodically.

A specific method for the media resource control device to update the saved capability information of each media resource processing device may include: the resource idleness information of the allocated media resource processing device is decreased after the media resource processing device is allocated for the resource operation request; and the resource idleness information of the released media resource processing device is increased after the media resource processing device is released. The method may further include: the resource occupation information of the allocated media resource processing device is increased after the media resource processing device is allocated for the resource operation request; and the resource occupation information of the released media resource processing device is decreased after the media resource processing device is released. Therefore, by keeping the consistency between the saved configuration information (i.e., the capability information of each media resource processing device that is saved by the media resource control device) and the actual information (i.e., the actual capability information of each media resource processing device), it can be ensured that media resources may be allocated appropriately according to the actual capability of the media resource processing device and load balancing may be realized.

The method for the media resource control device to allocate a media resource processing device for the current resource operation request according to the capability information of each media resource processing device that is updated most recently includes: if there is a media resource processing device of which the capability information meets the requirement of the resource operation request, the media resource processing device of which the capability information meets the requirement is allocated for the current resource operation request; otherwise, a media resource processing device of which the current resource idleness information is the largest or the resource occupation information is the smallest (i.e., the idlest media resource processing device) to the current resource operation request, or the current resource operation request is rejected. Here, user requirement may be considered as much as possible, and the requirement of the requesting entity may be met, so that user satisfaction may be improved. When there is no media resource processing device that can meet the requirement of the resource operation request, the current resource operation request may be rejected.

If there is only one media resource processing device that meets the requirement, the request will be sent to the media resource processing device for processing; if there are at least two media resource processing devices that meet the requirement, the idlest media resource processing device or the media resource processing device that is nearest to the resource operation requester (one skilled in the art may understand that resource operation requester refers to the requesting entity that initiates the resource operation request) will be selected for processing the request.

Additionally, when the media resource processing device does not provide a service, its resource idleness information will be set as null, and thus the media resource processing device will no longer be selected to process the received resource operation request. Therefore, it may be avoided that some media resource processing devices will still be accessed after they quit a service, and wrong resource allocation may be prevented.

The media resource control device may also obtain the capability information of each media resource processing device during initialization according to data configured by a terminal, and record the capability information.

The media resource control device may also audit the capability information of each media resource processing device periodically, and update the capability information recorded locally according to the audit result; and/or each media resource processing device may report the capability information to the media resource control device periodically, and the media resource control device updates the capability information recorded locally according to the capability information reported by each media resource processing device. In a further example, the process of the method for allocating media resources is described as follows:

An MRFC keeps resource capability information of MRFPs during operation and selects an appropriate MRFP according to resource capability of a resource operation request when receiving the request. During the process of processing the resource request, the MRFC needs to analyze the resource capability of the request, select an appropriate MRFP for processing the request, and decrease the resource idleness information of the selected MRFP; when the resources are no longer used and released, the resource idleness information of the corresponding MRFP will be increased; in other words, the resource idleness information of the MRFP is updated dynamically during the process.

If it is found that only one MRFP can meet the requirement of the resource capability of the request, only this MRFP can be selected, so that resource processing failure caused by selecting other MRFPs may be avoided.

If it is found that there are a plurality of MRFPs that can meet the requirement of the resource capability of the request, the idlest MRFP or the MRFP that is nearest to the location of the resource requester may be selected, or an appropriate MRFP may be selected according to other requirements.

If it is found that an MRFP is busy and occupies many resources, other MRFPs will be selected by a subsequent resource operation request. Therefore, traffic control of MRFPs of different states and the load balancing among each MRFP may be realized.

When the MRFC selects an MRFP to provide media resource capability, the MRFC needs to synchronously decrease the capability information of the corresponding MRFP that is saved by the MRFC (mainly capability information about resources), so that it may be avoided that the saved capability information is incorrect and that errors occur in the subsequent resource allocation; when the resources are released, the MRFC needs to increase the capability information.

When an MRFP moves out a service completely, it needs to set all the resources on the MRFP as unavailable; in other words, the idle resource is null, and the resources on the MRFP will no longer be selected.

The resource state on the MRFC and the MRFP may be reported periodically via a periodic audit message or an MRFP state message to prevent the specific resource state on the MRFC and the MRFP from inconsistency, so that the state may be kept consistent.

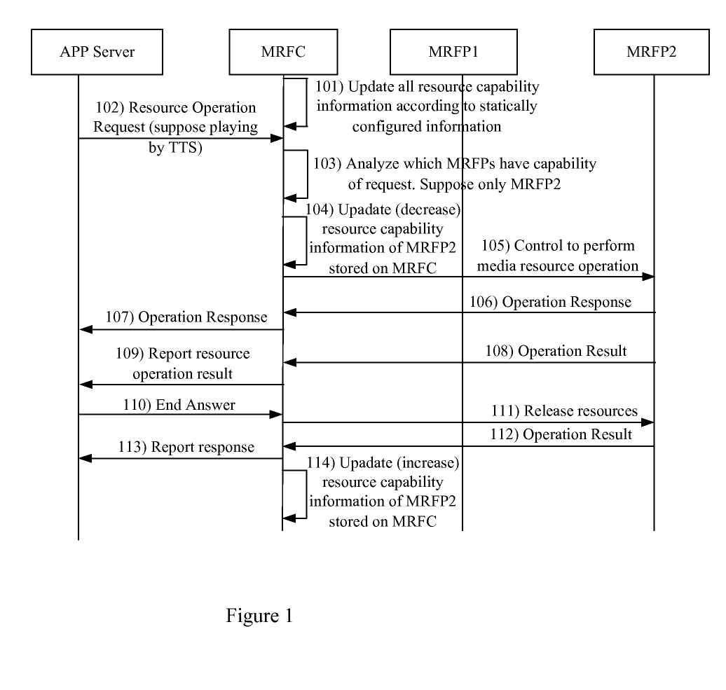

FIG. 1 shows a flow chart of a method for allocating media resources:

101: When an MRFC is initialized or after an MRFC is operated, the MRFC initializes the resource capability information of all the administrated MRFPs according to information configured by a user terminal, or the MRFC updates the resource capability information of all the MRFPs according to statically configured information during operation; and the MRFC saves the capability information of all the MRFPs.

102: The MRFC receives a resource operation request (for example, requesting to play a specified file by TTS) sent from a resource requesting entity (such as an APP Server or a terminal).

103-114: The MRFC analyzes resource capability needed by the resource operation request, and finds an MRFP that meets the resource capability requirement according to the needed resource capability and in conjunction with the saved capability information. If only one MRFP meets the capability requirement, the resource operation request will be sent to the MRFP for processing. (As shown in the Figure, MRFP2 meets the capability requirement. At this time, resource operation failure may be avoided that is caused by sending to an MRFP which does not support the resource operation due to the random distribution of the MRFC). The analysis process may be further described as follows: the media resource control device analyzes capability information of each media resource processing device according to the received resource operation request, and finds a media resource processing device that meets the request; if there is only one media resource processing device that meets the requirement, the request will be sent to the media resource processing device for processing; if there are a plurality of media resource processing devices that meet the requirement, the idlest media resource processing device or the media resource processing device that is nearest to the resource operation requester will be selected for processing the request.

During the process of processing the received resource operation request, the media resource control device dynamically updates the saved capability information of the media resource processing device. The dynamic update process may be as follows: when a media resource processing device is selected to be used, the resource idleness information of the selected media resource processing device will be decreased; when a media resource processing device is selected to be released, the resource idleness information of the selected media resource processing device will be increased. When a media resource processing device does not provide a service, its resource idleness information is set as null, for example, the information value will be “0” or “null”, which is an information identifier that indicates no service will be provided any more. When the media resource control device obtains such information, it will no longer select the media resource processing device for processing the received request.

105-113 may also be as follows: after MRFP2 receives a resource operation request, it processes the resource operation request and reports a resource operation response and result, and the MRFC reports the information to a resource requesting entity (in this embodiment, APP Server is taken as an example).

114 may also be as follows: during the process in which MRFP2 is operated, when an MRFP service is requested, the MRFC dynamically decreases the saved resource capability information of MRFP2; when the resources are released, the MRFC dynamically increases the saved resource capability information of MRFP2.

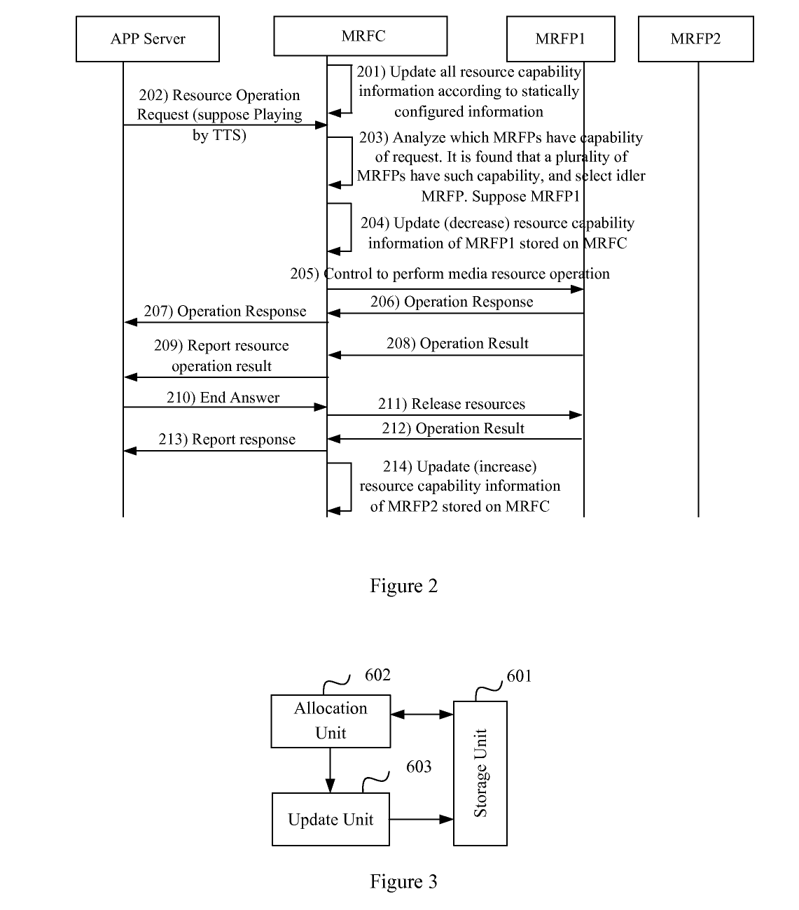

FIG. 2 shows another flow chart of a method for allocating media resources:

201: After an MRFC is operated, the MRFC updates resource capability information of all the MRFPs according to information configured by a user terminal, and the MRFC saves the capability information of all the MRFP.

202-204: The MRFC receives a resource operation request (for example, requesting to play a specified file by TTS) sent from a resource requesting entity (such as an APP Server). The MRFC analyzes the needed resource capability, and finds the MRFP that meets the resource capability requirement according to the needed resource capability. If there are a plurality of MRFPs that meet the capability requirement, the MRFC selects the idlest MRFP for processing the resource operation request.

In FIG. 2, MRFP1 is the idlest. At this time, resource load imbalance among each MRFP caused by random distribution of the MRFC may be avoided.

205-214: After MRFP1 receives a resource operation request, MRFP1 processes the resource operation request and reports a resource operation response and result, and the MRFC reports the information to the resource requesting entity (here, an APP Server). During the process in which MRFP1 is operated, when an MRFP service is requested, the MRFC dynamically decreases the saved resource capability information of MRFP1; when the resources are released, the MRFC dynamically increases the saved resource capability information of MRFP1.

An embodiment further discloses a media resource control device. Referring to FIG. 3, the device includes:

a storage unit 601 adapted to save capability information of each media resource processing device;

an allocation unit 602 adapted to allocate a media resource processing device for a resource operation request according to the capability information saved in the storage unit 601; and

an update unit 603 adapted to update capability information of a corresponding media resource processing device in the storage unit 601 each time the allocation unit 602 allocates a media resource processing device for a resource operation request or an allocated media resource processing device is released.

The device may further include an initialization unit adapted to obtain the capability information of each media resource processing device according to data configured by a terminal during the process of initializing the media resource control device, and provide the capability information to the storage unit. The initialization unit may be integrated with the storage unit 601, or they may also be provided independently.

The device may further include an audit unit adapted to audit the capability information of each media resource processing device periodically and update the capability information saved in the storage unit according to an audit result. The device may further include a receive unit adapted to receive the capability information reported by each media resource processing device, and update the capability information saved in the storage unit according to the reported capability information. The audit unit and the receive unit may be provided independently, or they may also be provided integrally, or they may also be integrated with the update unit 603 respectively, or the three units may also be integrated, according to different networking modes and the consideration of the related factors such as cost. Each of the above ways should be included in the scope of the disclosure. The audit unit and the receive unit are not necessarily included at the same time, and only one of them may be configured.

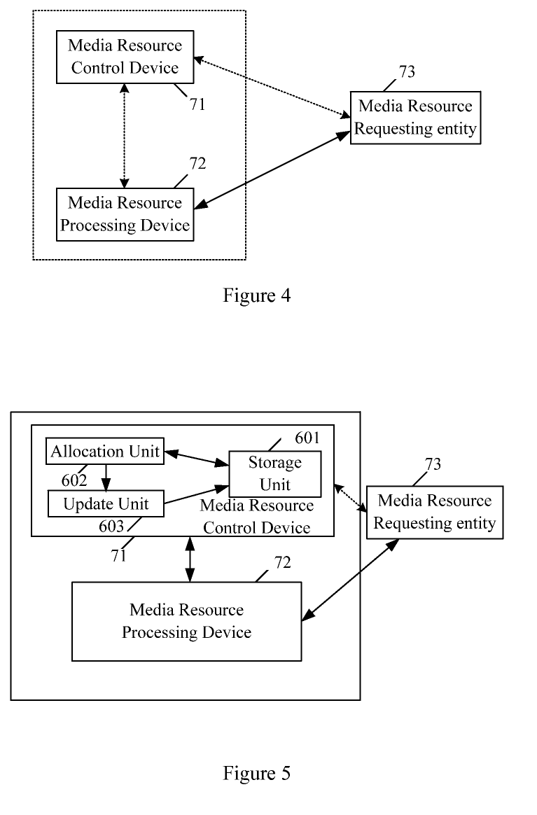

An embodiment further discloses a system for allocating media resources. Referring to FIG. 4 and FIG. 5, the system includes a media resource processing device 72 adapted to provide resources for a media resource operation request. The system further includes a media resource control device 71 adapted to allocate a media resource processing device for a media resource operation request. Also, the system may further include a media resource requesting entity 73, such as a broadband terminal, adapted to initiating a resource request. In the system:

The media resource control device 71 is adapted to update capability information of a corresponding media resource processing device recorded locally each time a media resource processing device is allocated for a resource operation request or an allocated media resource processing device is released, and allocate media resource processing device 72 for the current resource operation request according to the capability information of each media resource processing device 72 updated most recently each time a resource operation request is received, and send allocation information to a corresponding media resource processing device 72.

Referring to FIG. 3 and FIG. 5, the media resource control device 71 further includes:

a storage unit 601 adapted to save capability information of each media resource processing device 72;

an allocation unit 602 adapted to allocate a media resource processing device 72 for a resource operation request according to the capability information saved in the storage unit 601;

an update unit 603 adapted to update capability information of a corresponding media resource processing device 72 in the storage unit 601 each time the allocation unit 602 allocates a media resource processing device 72 for a resource operation request or an allocated media resource processing device 72 is released.

The media resource control device 71 may further include an initialization unit adapted to obtain the capability information of the media resource processing device 72 according to data configured by a terminal when the media resource control device 71 is initialized, and save the capability information to the storage unit 601. The initialization unit may be provided in the media resource control device 71 independently, or it may also be integrated with the storage unit 601.

In order to prevent specific resource state information on the MRFC (a kind of media resource control device 71) and on the MRFP (a kind of media resource processing device 72) from being inconsistent, in other words, in order to dynamically update the capability information saved on the MRFC, the information state may be kept synchronous between the MRFC and the MRFP in the following manners: the media resource control device 71 periodically audits the capability message of each media resource processing device 72; or, each media resource processing device 72 periodically reports the capability message to the media resource control device 71.

The media resource control device 71 may further include an audit unit adapted to periodically audit the capability information of each media resource processing device 72 and update the capability information saved in the storage unit 601 according to an audit result; the audit unit may be provided independently, or it may also be integrated with the update unit 603.

The media resource processing device 72 may further include a response unit adapted to send the capability information of the media resource processing device 72 to the audit unit in response to the auditing of the audit unit.

The media resource processing device 72 further includes a report unit adapted to periodically report the capability information to the media resource control device 71.

The media resource control device 71 may further include a receive unit adapted to receive the capability information reported by each media resource processing device 72 periodically, and update the capability information saved in the storage unit 601 according to the reported capability information.

During the process of processing the received resource operation request, the media resource control device 71 dynamically updates the saved capability information of the media resource processing device 72. The dynamic update process may be further described as follows: when the media resource processing device 72 is selected to respond to the request, the resource idleness information of the selected media resource processing device 72 will be decreased; when the media resource processing device 72 is selected to be released, the resource idleness information of the selected media resource processing device 72 will be increased.

In various embodiments, the capability information saved in the media resource control device is updated after a media resource processing device is allocated for a resource operation request or an allocated media resource processing device is released. It should be understood that such a specific way is employed to dynamically update the capability information of each media resource control device that is saved by the media resource control device. In addition to the above specific way, other specific ways may also be employed to dynamically update the saved capability information. For example, the media resource control device may also audit the capability information of each media resource processing device periodically and update the capability information recorded locally according to an audit result; and/or each media resource processing device may report the capability information to the media resource control device periodically, and the media resource control device updates the capability information recorded locally according to the capability information reported by each media resource processing device. One skilled in the art should understand that the way for dynamically updating the capability information saved in the media resource control device includes, but is not limited to, the above three specific ways. Moreover, the above three specific ways may be used independently or in any combination.

In various embodiments, the idlest media resource processing device or the media resource processing device that is nearest to the resource operation requester will be selected for processing the request if there are a plurality of media resource processing devices that meet the requirement. One skilled in the art should understand that a balanced selection may be made by considering various indexes. For example, an appropriate media processing device may be selected for processing the request in a balanced selection way by considering idle degree with the distance from the resource operation requester. In conclusion, if there are a plurality of media resource processing devices that meet the requirement, one media resource processing device will be selected for processing the request according to a predetermined criterion.

In various embodiments, during the process of processing the received resource operation request, the media resource control device dynamically updates the saved capability information of the media resource processing device. The dynamic update process may be as follows: when a media resource processing device is selected to be used, the resource idleness information of the selected media resource processing device will be decreased; when a media resource processing device is selected to be released, the resource idleness information of the selected media resource processing device will be increased. When a media resource processing device does not provide a service, the resource idleness information of the media resource processing device is set as null. Additionally, the media resource control device may also audit the capability information of each media resource processing device periodically, or it may receive the capability information reported by each MRFP periodically and thereby dynamically update the saved capability information.

In various embodiments, the capability information of the media resource processing device that is saved in the storage unit 601 may be updated by the update unit 603 in time; and the capability information of the media resource processing device that is saved in the storage unit 601 may be updated by the audit unit or the receive unit periodically. No matter the capability information is updated in time or updated periodically, the dynamically updating the capability information of the media resource processing device that is saved in storage unit 601 may be attained. Therefore, for dynamically updating the capability information saved in the media resource processing device, the audit unit, the receive unit and the update unit 603 are not necessarily included at the same time, and only one of them may be configured. Furthermore, for obtaining a better dynamic update effect and improving update accuracy, the update unit 603 and the audit unit may be used in combination, or the update unit 603 and the receive unit may be used in combination. In other words, the capability information may be updated in time and periodically at the same time. Therefore, the update unit, the audit unit and the receive unit may be generalized as a dynamic update unit, which is adapted to dynamically update the capability information of the media resource processing device saved in the storage unit 601. The dynamic update unit may only include any one of the audit unit, the receive unit and the update unit 603, and the dynamic update unit may further include any two or all of them.

The above are preferred embodiments and they are illustrative of, but not limitative to the scope of the present disclosure.

What is claimed is:

1. A method for allocating media resources, comprising:
allocating a media resource processing device for a resource operation request according to saved capability information of each media resource processing device when the resource operation request is received; and
dynamically updating the saved capability information of each media resource processing device.

2. The method for allocating media resources according to claim 1, wherein the resource capability information comprises resource idleness information, and the process of dynamically updating the saved capability information of each media resource processing device comprises:
decreasing the resource idleness information of the media resource processing device after the media resource processing device is allocated for the resource operation request; or
increasing the resource idleness information of the media resource processing device after the allocated media resource processing device is released.

3. The method for allocating media resources according to claim 2, further comprising: setting the resource idleness information of the media resource processing device as null when the media resource processing device does not provide a service, and no longer selecting the media resource processing device to be allocated for the resource operation request.

4. The method for allocating media resources according to claim 1, wherein the resource capability information comprises resource occupation information and the process of dynamically updating the saved capability information of each media resource processing device comprises:
increasing the resource occupation information of the media resource processing device after the media resource processing device is allocated to the resource operation request; and
decreasing the resource occupation information of the media resource processing device after the allocated media resource processing device is released.

5. The method for allocating media resources according to claim 1, wherein the process of allocating a media resource processing device for a resource operation request according to saved capability information of each media resource processing device comprises:
allocating a media resource processing device of which the capability information meets a requirement of the resource operation request for the resource operation request if there is capability information that meets the requirement in the saved capability information of each media resource processing device; otherwise, allocating a media resource processing device that is the idlest currently for the resource operation request.

6. The method for allocating media resources according to claim 1, wherein the process of allocating a media resource processing device for a resource operation request according to saved capability information of each media resource processing device comprises:
allocating a media resource processing device of which the capability information meets a requirement of the resource operation request for the resource operation request if there is capability information that meets the requirement in the saved capability information of each media resource processing device; otherwise, rejecting the resource operation request.

7. The method for allocating media resources according to claim 5, wherein if the capability information of one media resource processing device meets the requirement of the resource operation request, the resource operation request will be sent to the media resource processing device for processing; if the capability information of at least two media resource processing devices meets the requirement of the resource operation request, one media resource processing device will be selected for processing according to a predetermined criterion.

8. The method for allocating media resources according to claim 2, wherein the capability information further comprises: resource classification information and/or capability type information.

9. The method for allocating media resources according to claim 1, wherein the process of dynamically updating the saved capability information of each media resource processing device comprises:
auditing the capability information of each media resource processing device periodically, and updating the saved capability information of each media resource processing device according to an audit result;
and/or
receiving the capability information reported by each media resource processing device periodically, and updating the saved capability information of each media resource processing device according to the reported capability information;
and/or
updating the saved capability information of a corresponding media resource processing device each time a media resource processing device is allocated for a resource operation request or an allocated media resource processing device is released.

10. The method for allocating media resources according to claim 1, further comprising:
obtaining the capability information of each media resource processing device during initialization according to data configured by a terminal, and saving the obtained capability information.

11. A media resource control device, comprising:
a storage unit adapted to save capability information of each media resource processing device;
an allocation unit adapted to allocate a media resource processing device for a resource operation request according to the capability information saved in the storage unit; and
a dynamic update unit adapted to dynamically update the capability information of each media resource processing device saved in the storage unit.

12. The media resource control device according to claim 11, wherein the dynamic update unit comprises:
an audit unit adapted to audit the capability information of each media resource processing device periodically, and update the capability information of each media resource processing device saved in the storage unit according to an audit result;
and/or
a receive unit adapted to receive the capability information reported by each media resource processing device periodically, and updating the capability information of the media resource processing device saved in the storage unit according to the reported capability information;
and/or
an update unit adapted to update the capability information of a corresponding media resource processing device saved in the storage unit each time the allocation unit allocates a media resource processing device for a resource operation request or an allocated media resource processing device is released.

13. The media resource control device according to claim 11, further comprising:
an initialization unit adapted to obtain the capability information of each media resource processing device according to data configured by a terminal when the media resource control device is initialized, and saving the capability information to the storage unit.

14. A system for allocating media resources, comprising media resource processing devices each adapted to provide resources for a media resource operation request, wherein the system further comprises a media resource control device adapted to allocate a media resource processing device to a resource operation request according to capability information of each media resource processing device saved currently when the resource operation request is received, and dynamically update the saved capability information of each media resource processing device.

15. The system for allocating media resources according to claim 14, wherein the media resource control device comprises:
a storage unit adapted to save the capability information of each media resource processing device;
an allocation unit adapted to allocate the media resource processing device to the resource operation request according to the capability information saved in the storage unit; and
a dynamic update unit adapted to dynamically updating the capability information of each media resource processing device in the storage unit.

16. The system for allocating media resources according to claim 15, wherein the media resource control device further comprises an initialization unit adapted to obtain the capability information of each media resource processing device according to data configured by a terminal when the media resource control device is initialized, and save the capability information to the storage unit.

17. The system for allocating media resources according to claim 15, wherein the dynamic update unit comprises an audit unit adapted to audit the capability information of each media resource processing device periodically and updating the capability information saved in the storage unit according to an audit result; and
the media resource processing device further comprises a response unit adapted to send the capability information of the media resource processing device to the audit unit in response to the auditing of the audit unit.

18. The system for allocating media resources according to claim 15, wherein the media resource processing device further comprises a report unit adapted to report the capability information to the media resource control device periodically;
the dynamic update unit in the media resource control device comprises a receive unit adapted to receive the capability information reported by each media resource processing device periodically, and update the capability information saved in the storage unit according to the reported capability information.

19. The system for allocating media resources according to claim 15, wherein the dynamic update unit in the media resource control device comprises:
an update unit adapted to update the capability information of a corresponding media resource processing device saved in the storage unit each time the allocation unit allocates a media resource processing device for a resource operation request or an allocated media resource processing device is released.
